(19) United States
(12) Patent Application Publication
(10) Pub. No.: US 2020/0151212 A1
(43) Pub. Date: May 14, 2020

(54) MUSIC RECOMMENDING METHOD, DEVICE, TERMINAL, AND STORAGE MEDIUM

(71) Applicant: Baidu Online Network Technology (Beijing) Co., Ltd., Beijing (CN)

(72) Inventors: Jianlong Li, Beijing (CN); Xiangtao Jiang, Beijing (CN); Miaochang Zhang, Beijing (CN); Chenxi Gao, Beijing (CN); Shiquan Ye, Beijing (CN)

(21) Appl. No.: 16/554,185

(22) Filed: Aug. 28, 2019

(30) Foreign Application Priority Data
Nov. 13, 2018 (CN) 201811348755.5

(51) Int. Cl. G06F 16/635; G10L 15/22; G10L 25/63; G06F 3/16; G10L 25/54; G06F 16/638

(52) U.S. Cl. CPC G06F 16/635; G10L 15/22; G10L 25/63; G10L 2015/223; G10L 25/54; G06F 16/636; G06F 16/639; G06F 3/165

(57) ABSTRACT

A music recommending method, device, apparatus and a computer-readable storage medium are provided. The method includes: acquiring a user speech for performing speech control; identifying the user speech, and acquiring tone information of the user speech, wherein the tone information of the user speech includes at least one of a speech speed, a speech volume, and emotion information of the user speech; and determining a recommending result for recommending music according to the tone information of the user speech. A quality of the recommended music can be improved by using the present application.

### CROSS-REFERENCE TO RELATED APPLICATION

This application claims priority to Chinese Patent Application No. 201811348755.5, entitled “Music Recommending Method, Device, Terminal, and Storage Medium”, and filed on Nov. 13, 2018, which is hereby incorporated by reference in its entirety.

### TECHNICAL FIELD

The present application relates to a field of computer technology, and in particular, to a music recommending method and device, a terminal, and a storage medium.

### BACKGROUND

With the development of the mobile Internet, users thereof can enjoy music or perform interaction through a music App (Application, computer application) on a mobile device. Functions in the music app used by the users of the mobile internet are usually search and recommendation. A desirable song for a user can be quickly and accurately searched, which depends on resources and retrieval architecture provided by a server. However, the music recommendation is generally relatively complex, and have no specific standard, which has a more unspecific requirement. For this, the quality of the music recommended to the user of the mobile internet may affect key indicators such as the duration of the user in listening to the songs and the duration of the interaction on the music APP.

As the hardware of the mobile device continues to be improved, a user speech of the user can be identified. Then, the music playing of the music APP is controlled according to the command in the identified user speech. During the speech control for music playing, how to improve the quality of the recommended music is a technical problem that needs to be solved.

### SUMMARY

A music recommending method and device, storage medium, and a terminal are provided according to embodiments of the present application, so as to at least solve the above technical problems in the existing technology.

According to a first aspect, a music recommending method for music includes:

acquiring a user speech for performing speech control;

identifying the user speech, and acquiring tone information of the user speech, wherein the tone information of the user speech includes at least one of a speech speed, a speech volume, and emotion information of the user speech; and

determining a recommending result for recommending music according to the tone information of the user speech.

In conjunction with the first aspect, in a first implementation of the first aspect of the present application, the determining a recommending result for recommending music according to the tone information of the user speech includes:

determining a type of music to be recommended according to the tone information of the user speech; and

searching for music in the type of music to be recommended, to determine the searched music as the recommending music.

In conjunction with the first implementation of first aspect, in a second implementation of the first aspect of the present application, the determining a type of music to be recommended according to the tone information of the user speech includes at least one of:

determining a rhythm type of the music to be recommended according to the speech speed of the user speech;

determining a style of the music to be recommended according to the emotion information of the user speech; and

determining an environment in which the user is located according to the speech volume of the user speech, and determining a rhythm type and a style of the music to be recommended according to the determined environment.

In conjunction with the first aspect, in a third implementation of the first aspect of the present application, in a case that the tone information of the user speech includes the emotion information of the user speech, the method further includes:

recommending the recommending music to the user in response to the recommending result;

acquiring behavior data of a user in a process of playing the recommended music; and

according to the acquired behavior data of the user, determining emotion information fed back by the user, to adjust the recommending result and obtain an adjusted recommending result.

In conjunction with the first aspect or any one of implementations of the first aspect, in a fourth implementation of the first aspect of the present application, the recommending result includes a music playlist having at least one piece of music; and the method further includes:

playing the at least one piece of music in the music playlist according to a sequence of the at least one piece of music in the music playlist;

acquiring a speech feedback from the user in a process of playing the music; and

adjusting the music playlist according to the speech feedback.

According to a second aspect, a music recommending device includes:

an acquiring module configured to acquire a user speech for performing speech control;

an identifying module configured to identify the user speech, and acquire tone information of the user speech, wherein the tone information of the user speech includes at least one of a speech speed, a speech volume, and emotion information of the user speech; and

a determining module configured to determine a recommending result for recommending music according to the tone information of the user speech.

In conjunction with the second aspect, in a first implementation of the second aspect of the present application, the determining module includes:

a first determining unit configured to determine a type of music to be recommended according to the tone information of the user speech; and

a second unit configured to search for music in the type of music to be recommended, to determine the searched music as the recommending music.

In conjunction with the first implementation of the second aspect, in a second implementation of the second aspect of the present application, the first determining unit includes at least one of the following:

a first determining sub-unit configured to determine a rhythm type of the music to be recommended according to the speech speed of the user speech;

a second determining sub-unit configured to determine a style of the music to be recommended according to the emotion information of the user speech; and

a third determining sub-unit configured to determine an environment in which the user is located according to the speech volume of the user speech, and determine a rhythm type and a style of the music to be recommended according to the determined environment.

In conjunction with the second aspect, in a first implementation of the second aspect of the present application, in a case that the tone information of the user speech includes the emotion information of the user speech, the device further includes:

a recommending module configured to recommend the recommending music to the user in response to the recommending result;

a data acquiring module configured to acquire behavior data of a user in a process of playing the recommended music; and

an adjusting module configured to, according to the acquired behavior data of the user, determine emotion information fed back by the user, to adjust the recommending result and obtain an adjusted recommending result.

In conjunction with the second aspect or any one of implementations of the second aspect, in a fourth implementation of the second aspect of the present application, the recommending result includes a music playlist having at least one piece of music; and the device further includes:

a music playing module configured to play the at least one piece of music in the music playlist according to a sequence of the at least one piece of music in the music playlist;

a feedback acquiring module configured to acquire a speech feedback from the user in a process of playing the music; and

a playlist adjusting module configured to adjust the music playlist according to the speech feedback.

In a third aspect, an embodiment of the present application provides a music recommending device. The functions of the music recommending device may be implemented by hardware, or may be implemented by hardware executing corresponding software. The hardware or software includes one or more modules corresponding to the functions described above.

In a possible design, the music recommending device includes a processor and a memory for store a program that, when executed by the processor, cause the processor to implement the music recommending method. The music recommending device may further include a communication interface for communicating with other devices or communication networks.

In a fourth aspect, a computer-readable storage medium is provided for storing computer software instructions used by the music recommending device, the storage medium includes programs involved in execution of the above method.

One of the above technical solutions has the following advantages or beneficial effects.

In the embodiment of the present application, a user speech for performing speech control on a music application can be acquired and the tone information of the user speech can be acquired therefrom. The tone information of the user speech includes at least one of a speech speed, a speech volume, and emotion information of the user speech. According to the tone information, the recommending result can be adjusted or determined to improve a quality of the recommended music.

The above summary is for the purpose of the specification only and is not intended to limit in any way. In addition to the illustrative aspects, embodiments, and features described above, further aspects, embodiments, and features of the present application will be readily understood by reference to the drawings and the following detailed description.

### BRIEF DESCRIPTION OF THE DRAWINGS

In the drawings, unless otherwise specified, identical reference numerals will be used throughout the drawings to refer to identical or similar parts or elements. The drawings are not necessarily drawn to scale. It should be understood that these drawings depict only some embodiments disclosed in accordance with the present application and are not to be considered as limiting the scope of the present application.

FIG. 1 is a schematic flowchart of a music recommending method according to an embodiment of the present invention.

FIG. 2 is a schematic flowchart of a process for determining a recommending result according to an embodiment of the present invention.

FIG. 3 is a schematic flowchart of a process for adjusting a type of music to be recommended according to an embodiment of the present invention.

FIG. 4 is a schematic flowchart of a process for adjusting a recommending result according to an embodiment of the present invention.

FIG. 5 is a schematic flowchart of a process for adjusting a music playlist according to an embodiment of the present invention.

FIG. 6 is a schematic structural diagram of a music recommending device according to an embodiment of the present invention;

FIG. 7 is a schematic structural diagram of an embodiment of a terminal according to the present application.

### DETAILED DESCRIPTION OF THE EMBODIMENTS

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

With reference to FIG. 1, a music recommending method is provided according to an embodiment of the present application. This embodiment may be applied to an audio player or audio website, such as, Kugou, NetEase cloud music, a shrimp audio player and the like. This embodiment may be also applied to video players or video sites, such as music video (MV) which is used to recommend music. Video players can include Youku, iQIYI, DOUYIN, and so on. An audio player or a video player is an application program installed on a user terminal, for example, Smartphones, computers, tablets, and so on. The method in this embodiment includes S100 to S300.

At S100, a user speech for performing speech control is acquired. Here, the speech control may include normal operations such as searching, collecting, playing and pausing of the music. The speech control can also include logging in, logging out, setting an application for playing the music, and so on. A music application may include an application that can play music, such as the above audio player or video player.

This embodiment may be applied in a scenario that the user interacts with the music application installed in a user terminal, for example, the user clicks on the music application or inputs data into the music application to search, collect, play music, and so on. For another example, when the user issues the user speech, speech information can be sent to the music application through a microphone provided by the user terminal. A control instruction carried in the speech information may be identified by the music application. The music application can be controlled through the control instruction to perform searching, collecting, playing music, and so on.

At S200, the user speech is identified, and tone information of the user speech is acquired, wherein the tone information of the user speech includes at least one of a speech speed, a speech volume, and emotion information of the user speech.

In some embodiments, an identification model may be trained to identify the tone information of the user speech in advance, such as the speech speed, the speech volume, the emotion information, and breathing sound of the user speech.

Taking the exemplary tone as an example, a speech speed identification model, a volume identification model, an emotion identification model and a breathing identification model can be trained in advance. Then, the speech speed of the user speech can be acquired with the speech speed identification model to identify the user speech. The speech volume of the user speech can be acquired with the volume identification model to identify the user speech. The emotion information can be acquired with the emotion identification model to identify the user speech. The breathing sound of the user can be acquired with the breathing identification model to identify the user speech.

Here, the speech speed identification model can be generated by using a large amount of training data on the speech speed. The training data on the speech speed can include sample user speeches and sample speech speeds. The volume identification model can be generated by using a large amount of training data on the speech volume. The training data on the speech volume can include sample user speeches and sample volumes. The emotion identification model can be generated by using a large amount of training data on the emotion. The training data on the emotion can include sample user speeches and sample emotions. The breathing identification model can be generated by a large amount of training data on breathing sound. The training data on breathing sound can include sample user speeches and sample breathing sounds.

The same one user speech is identified by using a plurality of sub-identification models to achieve parallel identification and to improve an identification efficiency. In addition, this can be achieved technically since the sub-identification model is trained more easily and has a high identification accuracy.

At S300, a recommending result for recommending music is determined according to the tone information of the user speech.

In this embodiment, music may include classical music, pop music, blues songs, rock music, jazz music, orchestral music, modern music, and the like. It can also be classified in the form of music, such as percussion, ensemble, orchestra, piano, and the like. Music can include songs, MVs, and the like. The MV can be a short video with a song.

In some embodiments, the requirements of the user may be determined according to the user speech, and the recommending result for recommending music may be obtained according to the requirements of the user. For example, the user says “I want to listen to Beethoven”, and a music list written by Beethoven may be retrieved by using the music application. Furthermore, according to the tone information of the user speech, the music to be recommended in the music list may be filtered. A filtering result is determined to be the recommending result for recommending music to the user. For example, in a case that the tone information for “I want to listen to Beethoven” is identified and the speech speed of the user speech is determined to be fast and the user emotion is sad, music with strong rhythm and positive expression is selected from the music list to encourage the user to be active and optimistic.

The embodiments of the present application can improve the quality of recommending music by obtaining the tone information of the user speech, and then combining the tone information into the recommending result for recommending music.

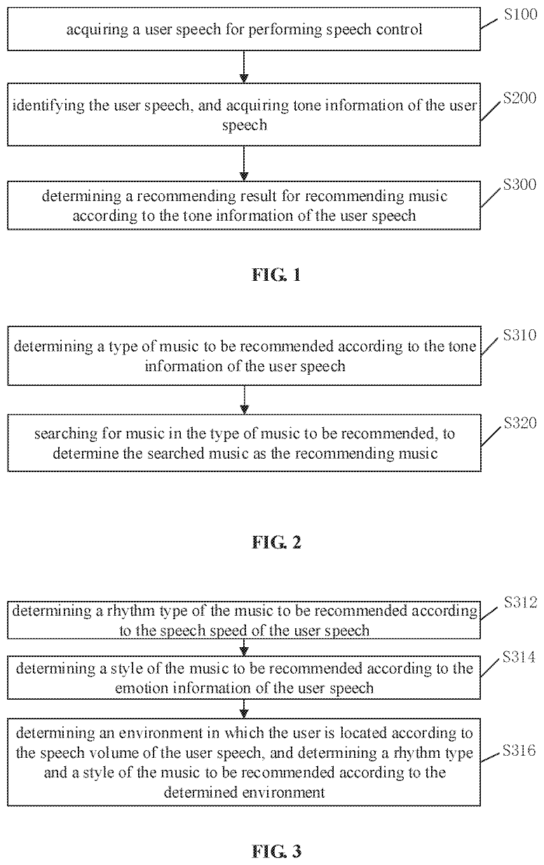

In some implementations, in a case that the user does not give an explicit requirement, a type of music to be recommended can be determined according to the tone information. As shown in FIGS. 2, S310 and S320 may be included in step S300.

At S310, a type of music to be recommended is determined according to the tone information of the user speech.

At S320, music in the type of music to be recommended is searched for to determine the searched music as the recommending music.

Since the tone information of the user speech can include at least one of the a speech speed, a speech volume and emotion information of the user speech, the type of music can be determined according to a type of the tone contained in the tone information of the user speech.

In a case that the tone information of the user speech includes the speech speed of the user speech, the rhythm type of the music to be recommended can be determined. For example, in a case that the user is speaking with a high speech speed, it indicates that the user is busy currently. At this point, some music with a stronger rhythm can be recommended. In a case that the user is speaking with a low speech speed, it indicates that the user is in a peaceful and relaxed state currently. At this point, some relaxed, quiet music can be recommended.

In a case that the tone information of the user speech includes emotion information of the user, the style of the music to be recommended can be determined. For example, in a case that the user speech indicates that the user is happy, some cheerful music can be recommended. In a case that the user speech indicates that the user is in a state of loss, some music to soothe the soul of the user can be recommended.

In a case that the tone information of the user speech includes the speech volume of the user speech, the environment in which the user is located can be determined. The speech volume of the user speech can also indicate a distance between the user and the user terminal receiving the user speech. Then, the type of the music to be recommended is determined by using the environment in which the user is located and the distance between the user and the user terminal that receives the user speech. For example, in a case that the speech volume is too high or the distance between the user and the user terminal that receives the speech is too long, the music with a higher pitch than a harmonic, or the more lively music, can be recommended, so that the user can enjoy music better in the environment in which the user is located. In a case that the speech volume is lighter, according to the environment in which the user is located, too noisy music is not recommended to avoid user being uncomfortable.

In this embodiment, a recommending result is acquired according to one or more tone terms included in the tone information of the user speech. During searching, the music can be searched for in a local music library or in other music libraries on the Internet.

In some embodiments, as shown in FIG. 3, step S310 may include at least one of steps from S312 to S316.

At S312, a rhythm type of the music to be recommended is determined according to the speech speed of the user speech. The rhythm type can include strength and weakness of rhythm, compactness and looseness of rhythm, and so on. The larger the speech speed of the user speech is, the stronger and more compact rhythm of the music to be recommended is.

At S314, a style of the music to be recommended is determined according to the emotion information of the user speech. The style of the music to be recommended can include bright and cheerful music, melancholy music, inspirational music, gentle music, and so on.

At S316, an environment in which the user is located is determined according to the speech volume of the user speech, and a rhythm type and a style of the music to be recommended is determined according to the determined environment. For example, in a case that the speech volume is large and there is a large amount of noise around the user, it may be determined that the user is in a noisy environment, which is suitable for playing loud music. In a case that the speech volume is light and there is less noise around the user, it may be determined that the user is in a quiet environment, which is not suitable for playing too noisy music.

In some embodiments, in a case that the rhythm type and style of the music to be recommended currently is determined by S312 and S314 to be strong and compact, but it is determined by S316 that the too noisy music is not suitable currently, the noisy music is filtered out of the music with strong and compact rhythm, and the remaining music after filtering may be recommended to the user for playing.

In some implementations, in a case that the tone information of the user speech includes the emotion information of the user speech, during the music recommending, the emotion information of the user speech can be supported according to the emotion information fed back by behavior data of the user in a process of playing the recommending music. Then, according to a result of the supporting, the recommending result for recommending music is updated, thereby further improving quality of the recommended music. As shown in FIG. 4, the recommending result updating process provided in this embodiment may include steps from S410 to S430:

At S410, the recommending music is recommended to the user in response to the recommending result.

In some embodiments, a list of the recommended music may be provided to the user, from which the user determines a sequence and a start point for playing music. The music can played by the music application according to the sequence and start point determined by the user.

In some embodiments, the list of the recommended music may be provided to the user, and the music in this list starts may be played in a default sequence.

At S420, behavior data of a user in a process of playing the recommended music is acquired.

Here, the behavior data of the user in a process of playing the recommended music can include behaviors of whether the recommended music is completely played or not, the number of repetitions, whether playing of a song is stopped or not, and searching music similar to the recommended music or the music in the same album, and the like.

When a user listens to music, in a case that the user is not interested in a song, he/she will switch to the next song. In a case that a user is interested in a song, the song is usually played completely or repeatedly. Therefore, a preference degree of the user in the recommended music can be analyzed through the behavior data of the user.

At S430, according to the acquired behavior data of the user, emotion information fed back by the user is determined, to adjust the recommending result and obtain an adjusted recommending result.

In this embodiment, the emotion information fed back by the user is generally the preference degree of the user in the recommended music. For example, the user likes music A, is not interested in music B, and does not like music C, and so on. The recommending frequency of this music in the next recommending process can be adjusted, according to the preference degree of the user in the recommended music.

For example, in a case that the music A in the recommending result obtained for the first time is stopped by the user, it indicates that the user is not interested in the music A rather than that the user does not like the music A. The reason for this may be that the user did not want to listen to the music A in the current recommending result since he/she had already listened to it. The reason may also be that the user really does not like the music A. At this point, the recommending frequency of the music A can be reduced in the next recommending result for determining the true attitude of the user. In a case that during the next recommendation, the user still stops playing the music A, which indicates that the user does not like the music A, so that no more determination is required subsequently. The music A is filtered out of the next recommending result, and is no longer recommended to the user. In a case that during the next music recommending, the user does not stop playing the music A, which indicates that the music is irresponsive for the user, and thereby the music A will be recommended to the user in the future.

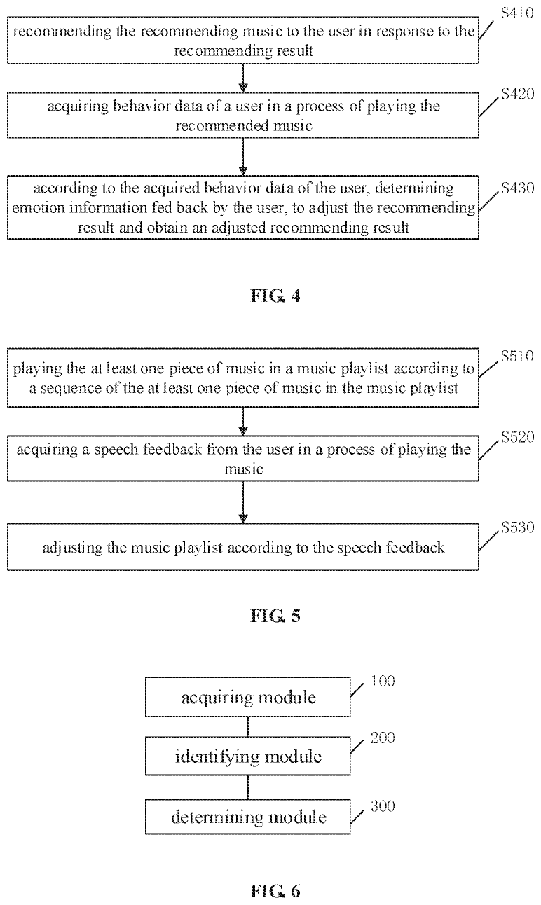

In some embodiments, the recommending result may include a music playlist. During playing the music in the music playlist, a speech feedback from the user can be acquired to adjust the recommended music in the music playlist and improve the recommending quality. Particularly, as shown in FIG. 5, the adjusting of the music playlist provided in this embodiment may include steps from S510 to S530.

At S510, the at least one piece of music in the music playlist is played according to a sequence of the at least one piece of music in the music playlist.

In some embodiments, the user can select a start position in the music playlist. In a case that the user does not select the start position for playing music, the music is played from the top of the playlist.

At S520, a speech feedback from the user in a process of playing the music is acquired.

Here, the speech feedback from the user may include replaying a piece of music, stopping to play the next piece of music, pausing a piece of music, and so on, and can include a preference degree of the user for one or more pieces of music or the whole music list. For example, in a case that the user says “This piece of music is good” and the piece of music A is currently being played, which indicates that the user is more interested in the piece of music A. In a case that the user says “I like all of music which are being played, I can hear them repeatedly for one day” and the list B is currently being played, which indicates that the user is satisfied with the list B.

At S530, the music playlist according to the speech feedback is adjusted.

Through the speech feedback, the preference degree of the user can be acquired. The current music playlist can be adjusted according to the preference degree of the user for the at least one piece of music or the playlist so that the user will be more satisfied with the adjusted playlist when it is played next time.

For example, in a case that the user likes the piece of music A, the piece of music A remains in the playlist, or the piece of music A can be placed on the top. In a case that the user does not like the piece of music B, it can be positioned at the bottom or removed from the playlist. In a case that the user does not like the entire playlist C, a new playlist can be provided to the user. In a case that the user likes the playlist C very much, the list C will not be adjusted.

In some embodiments, the volume of the loudspeaker for playing music can also be adjusted according to the identified volume. Particularly, in a case that the tone information of the user speech includes the speech volume of the user speech, the playing volume of the recommended music can be determined according to the speech volume of the user speech. Then, the volume of the loudspeaker for playing the music is adjusted according to the playing volume. For example, the bigger volume the user gives a speech, the bigger the volume of the loudspeaker.

With reference to FIG. 6, a music recommending device is provided according to an embodiment of the present application, including:

an acquiring module 100 configured to acquire a user speech for performing speech control;

an identifying module 200 configured to identify the user speech, and acquire tone information of the user speech, wherein the tone information of the user speech includes at least one of a speech speed, a speech volume, and emotion information of the user speech; and

a determining module 300 configured to determine a recommending result for recommending music according to the tone information of the user speech.

In one implementation, the determining module includes:

a first determining unit configured to determine a type of music to be recommended according to the tone information of the user speech; and

a second unit configured to search for music in the type of music to be recommended, to determine the searched music as the recommending music.

In one implementation, the first determining unit includes at least one of the following:

a first determining sub-unit configured to determine a rhythm type of the music to be recommended according to the speech speed of the user speech;

a second determining sub-unit configured to determine a style of the music to be recommended according to the emotion information of the user speech; and

a third determining sub-unit configured to determine an environment in which the user is located according to the speech volume of the user speech, and determine a rhythm type and a style of the music to be recommended according to the determined environment.

In one implementation, in a case that the tone information of the user speech includes the emotion information of the user speech, the device further includes:

a recommending module configured to recommend the recommending music to the user in response to the recommending result;

a data acquiring module configured to acquire behavior data of a user in a process of playing the recommended music; and

an adjusting module configured to, according to the acquired behavior data of the user, determine emotion information fed back by the user, to adjust the recommending result and obtain an adjusted recommending result.

In one implementation, the recommending result includes a music playlist having at least one piece of music, and the device further includes:

a music playing module configured to play the at least one piece of music in the music playlist according to a sequence of the at least one piece of music in the music playlist;

a feedback acquiring module configured to acquire a speech feedback from the user in a process of playing the music; and

a playlist adjusting module, configured to adjust the music playlist according to the speech feedback.

The functions of the device may be implemented by hardware, or may be implemented by hardware executing corresponding software. The hardware or software includes one or more modules corresponding to the functions described above.

In a possible design, the configuration for music recommending includes a processor and a memory configured to execute a program for music recommending in the first aspect of the above-described music recommending device, the processor configured to execute the program stored in the memory. The music recommending device may further include a communication interface for communication between the music recommending device and other apparatus or communication networks.

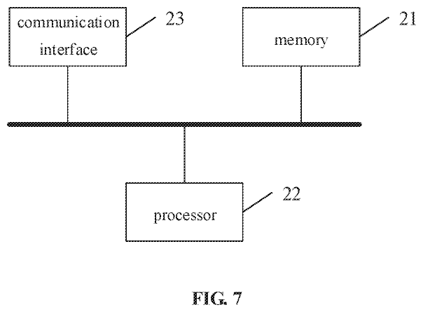

As shown in FIG. 7, a music recommending terminal apparatus is provided according to an embodiment of the present application. The apparatus includes a memory 21 and a processor 22. The memory 21 stores a computer program executable on the processor 22. When the processor 22 executes the computer program, the music recommending method in the foregoing embodiment is implemented. The number of the memory 21 and the processor 22 may be one or more.

The apparatus further includes:

a communication interface 23 for communication between the processor 22 and an external device.

The memory 21 may include a high-speed RAM memory and may also include a non-volatile memory, such as at least one magnetic disk memory.

If the memory 21, the processor 22, and the communication interface 23 are implemented independently, the memory 21, the processor 22, and the communication interface 23 may be connected to each other through a bus and communicate with one another. The bus may be an Industry Standard Architecture (ISA) bus, a Peripheral Component Interconnect (PCI) bus, an Extended Industry Standard Component (EISA) bus, or the like. The bus may be divided into an address bus, a data bus, a control bus, and the like. For ease of illustration, only one bold line is shown in FIG. 7, but it does not mean that there is only one bus or one type of bus.

Optionally, in a specific implementation, if the memory 21, the processor 22, and the communication interface 23 are integrated on one chip, the memory 21, the processor 22, and the communication interface 23 may implement mutual communication through an internal interface.

According to an embodiment of the present application, a computer-readable storage medium is provided for storing computer software instructions, which include programs involved in execution of the above the method.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in traffic charts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically acquire the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A music recommending method, comprising:
acquiring a user speech for performing speech control;
identifying content of the user speech, and acquiring tone information of the user speech, wherein the tone information of the user speech comprises at least one of a speech speed, a speech volume, and emotion information of the user speech; and
determining a recommending result for recommending music based on the tone information of the user speech.

2. The music recommending method according to claim 1, wherein the determining a recommending result for recommending music according to the tone information of the user speech comprises:
determining a type of music to be recommended according to the tone information of the user speech; and
searching for music in the type of music to be recommended, to determine the searched music as the recommending music.

3. The music recommending method according to claim 2, wherein the determining a type of music to be recommended according to the tone information of the user speech comprises at least one of:
determining a rhythm type of the music to be recommended according to the speech speed of the user speech;
determining a style of the music to be recommended according to the emotion information of the user speech; and
determining an environment in which the user is located according to the speech volume of the user speech, and determining a rhythm type and a style of the music to be recommended according to the determined environment.

4. The music recommending method according to claim 1, wherein in a case that the tone information of the user speech comprises the emotion information of the user speech, the method further comprises:
recommending the recommending music to the user in response to the recommending result;
acquiring behavior data of a user in a process of playing the recommended music; and
according to the acquired behavior data of the user, determining emotion information fed back by the user, to adjust the recommending result and obtain an adjusted recommending result.

5. The music recommending method according to claim 1, wherein the recommending result comprises a music playlist having at least one piece of music; and the method further comprises:
playing the at least one piece of music in the music playlist according to a sequence of the at least one piece of music in the music playlist;
acquiring a speech feedback from the user in a process of playing the music; and
adjusting the music playlist according to the speech feedback.

6. A music recommending device, comprising:
one or more processors; and
a storage device configured for storing one or more programs, wherein
the one or more programs are executed by the one or more processors to enable the one or more processors to:
acquire a user speech for performing speech control;
identify content of the user speech, and acquire tone information of the user speech, wherein the tone information of the user speech comprises at least one of a speech speed, a speech volume, and emotion information of the user speech; and
determine a recommending result for recommending music according to the tone information of the user speech.

7. The music recommending device according to claim 6, wherein the one or more programs are executed by the one or more processors to enable the one or more processors to:
determine a type of music to be recommended according to the tone information of the user speech; and
search for music in the type of music to be recommended, to determine the searched music as the recommending music.

8. The music recommending device according to claim 7, wherein the one or more programs are executed by the one or more processors to enable the one or more processors to perform at least one of:
determine a rhythm type of the music to be recommended according to the speech speed of the user speech;
determine a style of the music to be recommended according to the emotion information of the user speech; and
determine an environment in which the user is located according to the speech volume of the user speech, and determine a rhythm type and a style of the music to be recommended according to the determined environment.

9. The music recommending device according to claim 6, wherein in a case that the tone information of the user speech comprises the emotion information of the user speech, the one or more programs are executed by the one or more processors to enable the one or more processors to:
recommend the recommending music to the user in response to the recommending result;
acquire behavior data of a user in a process of playing the recommended music; and
according to the acquired behavior data of the user, determine emotion information fed back by the user, to adjust the recommending result and obtain an adjusted recommending result.

10. The music recommending device according to claim 6, wherein the recommending result comprises a music playlist having at least one piece of music, and the one or more programs are executed by the one or more processors to enable the one or more processors to:
play the at least one piece of music in the music playlist according to a sequence of the at least one piece of music in the music playlist;
acquire a speech feedback from the user in a process of playing the music; and
adjust the music playlist according to the speech feedback.

11. A non-volatile computer-readable storage medium, in which a computer program is stored, wherein the computer program, when executed by a processor, causes a device to:
acquire a user speech for performing speech control;
identify content of the user speech;
acquire tone information of the user speech, wherein the tone information of the user speech comprises at least one of a speech speed, a speech volume, and emotion information of the user speech; and
determine a recommending result for recommending music based on the tone information of the user speech; and
play the recommending music on the loudspeaker of the device.

12. The computer-readable storage medium of claim 11, wherein when determining a recommending result for recommending music based on the tone information of the user speech, the program causes the device to:
determine a type of music to be recommended according to the tone information of the user speech; and
search for music in the type of music to be recommended, to determine the searched music as the recommending music.

13. The computer-readable storage medium of claim 12, wherein when determining a type of music to be recommended according to the tone information of the user speech, the program causes the device to determine a rhythm type of the music to be recommended according to the speech speed of the user speech.

14. The computer-readable storage medium of claim 12, wherein when determining a type of music to be recommended according to the tone information of the user speech, the program causes the device to determine a style of the music to be recommended according to the emotion information of the user speech.

15. The computer-readable storage medium of claim 12, wherein when determining a type of music to be recommended according to the tone information of the user speech, the program causes the device to:
determine an environment in which the user is located according to the speech volume of the user speech; and
determine a rhythm type and a style of the music to be recommended according to the determined environment.

16. The computer-readable storage medium of claim 11, wherein in a case that the tone information of the user speech comprises the emotion information of the user speech, the program causes the program to:
recommend the recommending music to the user in response to the recommending result;
acquire behavior data of a user in a process of playing the recommended music; and
according to the acquired behavior data of the user, determine emotion information fed back by the user, and adjust the recommending result.

17. The computer-readable storage medium of claim 11, wherein when the recommending result comprises a music playlist having at least one piece of music; the program causes the device to:
play the at least one piece of music in the music playlist according to a sequence of the at least one piece of music in the music playlist;
acquire a speech feedback from the user in a process of playing the music; and
adjust the music playlist according to the speech feedback.
